(19) United States
(12) Patent Application Publication
(10) Pub. No.: US 2022/0161890 A1
(43) Pub. Date: May 26, 2022

(54) MOTOR CONTROLLER FOR ELECTRIC BICYCLES

(71) Applicant: Praxis Works LLC, Santa Cruz, CA (US)

(72) Inventors: David EARLE, Santa Cruz, CA (US); Joseph PARIETTI, Santa Cruz, CA (US); Benno WANG, Taipei (TW)

(21) Appl. No.: 17/532,930

(22) Filed: Nov. 22, 2021

Related U.S. Application Data
(60) Provisional application No. 63/116,589, filed on Nov. 20, 2020.

(51) Int. Cl. B62M 6/50; B62J 45/415; B62M 6/60; B62M 9/00; B62J 45/412; G06N 20/00

(52) U.S. Cl. CPC B62M 6/50; B62J 45/4152; G06N 20/00; B62M 9/00; B62J 45/412; B62M 6/60

(57) ABSTRACT

An electric pedal-assist bicycle may have a drivetrain including a crankset and an electric motor (e.g., a hub motor). A motor controller of the bicycle is configured to dynamically drive the motor to propel the bicycle based on a plurality of inputs. The inputs include information received from one or more of the following: user-related input(s), vehicle-related sensor(s), environmental sensor(s), and software. For example, the controller may drive the motor based on pedaling cadence and vehicle pitch orientation.

### CROSS-REFERENCES

The following application is incorporated herein, in its entirety, for all purposes: U.S. Provisional Patent Application Ser. No. 63/116,589, filed Nov. 20, 2020.

### FIELD

This disclosure relates to systems and methods for motor controllers. More specifically, disclosed embodiments relate to hub motor controllers for use with electric bicycles.

### INTRODUCTION

Modern pedal-assist electric bicycles (also known as pedelecs) often feel like the motor is either on or off, regardless of the riding conditions or the pedaling characteristics of the rider. This may cause an uncomfortable riding sensation. Additionally, modern electric bicycles often utilize accurate but relatively expensive sensor components, such as strain gauge sensors, to provide input to a motor controller for controlling an electric drive system. These components can add to the purchasing and repair costs of the consumer.

### SUMMARY

The present disclosure provides systems, apparatuses, and methods relating to motor controllers for e-bike motors, such as hub motors.

In some examples, an electric pedal-assist bicycle includes: a wheel rotatably coupled to a frame; a drivetrain configured to drive the wheel, the drivetrain including a crankset and an electric motor; a pedaling sensor configured to determine pedaling cadence information; an orientation sensor configured to determine a pitch orientation of the bicycle; and an electronic controller configured to drive the motor to propel the bicycle based on the pedaling cadence information and the pitch orientation.

In some examples, an electric pedal-assist bicycle includes: a wheel rotatably coupled to a frame; a drivetrain configured to drive the wheel, the drivetrain including a crankset, a drive chain, and an electric hub motor; an orientation sensor configured to determine pitch orientation information of the bicycle; and an electronic controller configured to drive the motor to propel the bicycle based on the pitch orientation information.

In some examples, a method for controlling an electric motor of an electric pedal-assist bicycle includes: dynamically increasing an output of a motor of an electric pedal-assist bicycle using an electronic controller of the bicycle, based on an indication that the bicycle is traveling uphill; and dynamically decreasing an output of the motor of the electric pedal-assist bicycle using the electronic controller of the bicycle, based on an indication that the bicycle is traveling downhill; wherein the indication that the bicycle is traveling uphill and the indication that the bicycle is traveling downhill are each based on bicycle orientation information and a pedaling cadence.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an electric bicycle hub motor controller in accordance with aspects of the present disclosure.

FIG. 2 is a schematic diagram of illustrative user inputs suitable for use with the electric bicycle hub motor controller of FIG. 1.

FIG. 3 is a schematic diagram of illustrative vehicle sensors suitable for use with the electric bicycle hub motor controller of FIG. 1

FIG. 4 is a schematic diagram of illustrative environmental inputs suitable for use with the electric bicycle hub motor controller of FIG. 1.

FIG. 5 is a schematic diagram of illustrative software inputs suitable for use with the electric bicycle hub motor controller of FIG. 1.

FIG. 6 is a schematic diagram depicting an illustrative machine learning (ML) system suitable for use with aspects of the present disclosure.

FIG. 7 is a schematic diagram of an illustrative data processing system, also referred to as a computer.

FIG. 8 is a schematic diagram of an illustrative distributed data processing system, also referred to as a computer network.

### DETAILED DESCRIPTION

A motor controller utilizing less expensive components while maintaining a high level of accuracy and comfort would reduce the cost passed on to the consumer without compromising on performance and provide a more realistic riding sensation.

Various aspects and examples of an electric bicycle hub motor controller are described below and illustrated in the associated drawings. Unless otherwise specified, a motor controller in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

The terms “inboard,” “outboard,” “forward,” “rearward,” and the like are intended to be understood in the context of a host vehicle on which systems described herein may be mounted or otherwise attached. For example, “outboard” may indicate a relative position that is laterally farther from the centerline of the vehicle, or a direction that is away from the vehicle centerline. Conversely, “inboard” may indicate a direction toward the centerline, or a relative position that is closer to the centerline. Similarly, “forward” means toward the front portion of the vehicle, and “rearward” means toward the rear of the vehicle. In the absence of a host vehicle, the same directional terms may be used as if the vehicle were present. For example, even when viewed in isolation, a device may have a “forward” edge, based on the fact that the device would be installed with the edge in question facing in the direction of the front portion of the host vehicle.

“Coupled” means connected, either permanently or releasably, whether directly or indirectly through intervening components.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

“Providing,” in the context of a method, may include receiving, obtaining, purchasing, manufacturing, generating, processing, preprocessing, and/or the like, such that the object or material provided is in a state and configuration for other steps to be carried out.

“GPS” means “Global Positioning System.”

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, electric bicycle hub motor controllers of the present disclosure are configured to receive a plurality of inputs (e.g., vehicle sensors, user inputs, software inputs, environmental inputs, etc.) and, in response, automatically provide a driving signal to a hub motor. (Although hub motors are described, any suitable electric motor may be utilized in the examples below). A crankset of the electric bicycle (AKA e-bike) may be configured to drive the bicycle using human-powered motion (i.e., pedaling) through a drive train. The hub motor is configured to directly drive one or both of the wheels, for example on an as-needed or supplemental basis.

One or more of the inputs received by the motor controller may include data relating to a mechanical input of the user, such as data from a pedaling cadence sensor. The motor controller is configured to utilize the mechanical input data to adjust one or more operating parameters of the hub motor (e.g., speed, torque, etc.).

One or more of the inputs received by the motor controller may include data relating to motion of the bicycle, such as speed, acceleration, etc. The motor controller is configured to utilize the motion data to adjust one or more operating parameters of the hub motor.

One or more of the inputs received by the motor controller may include data relating to an ambient environment of the electric bicycle, such as wind speed, wind direction, ambient temperature, etc. The motor controller is configured to utilize the environmental data to adjust one or more operating parameters of the hub motor.

One or more of the inputs received by the motor controller may include inputs from a (e.g., external) software application, such as data from GPS or other mapping software. The motor controller is configured to utilize the software input data to adjust one or more operating parameters of the hub motor.

Aspects of the motor controller may be embodied as a computer method, computer system, or computer program product. Accordingly, aspects of the motor controller may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the motor controller may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of motor controller may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C #, HTMLS, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the motor controller may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the motor controller. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative motor controllers, as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Hub Motor Controller

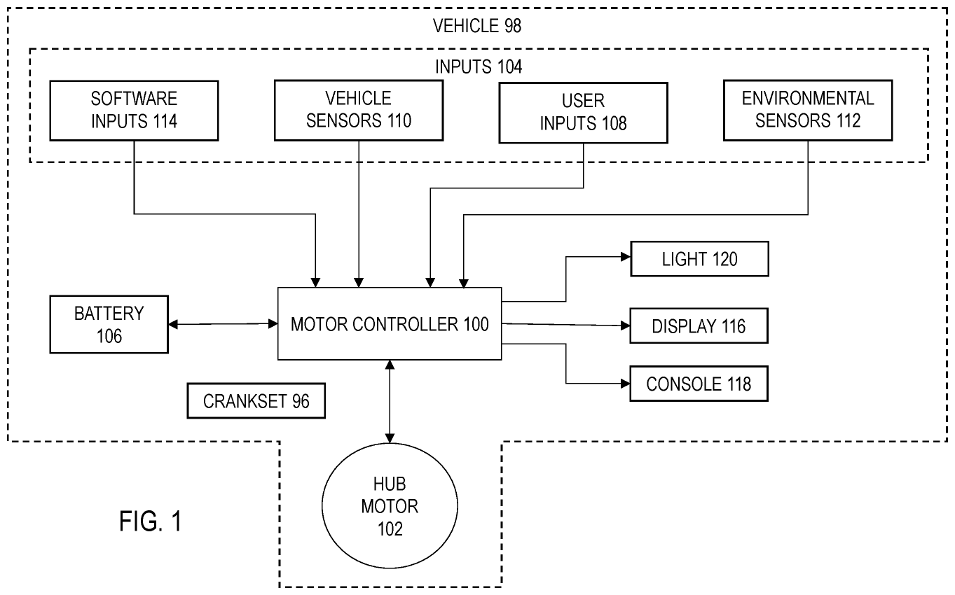

As shown in FIGS. 1-5, this section describes an illustrative hub motor controller 100. Hub motor controller 100 is an example of the hub motor controller described above. The motor controller of the present embodiment provides a driving signal to a hub motor for use with an electric bicycle.

Generally, the electric bicycle is a two-wheeled vehicle, with a front wheel rotatably coupled to a frame by a front fork assembly. The front fork is steerable by way of a handlebar. The frame further comprises a rear triangle having a rear wheel. The electric bicycle further includes a crankset configured as a human-powered input to a drive train coupled to the rear wheel. The crankset is supplementally operable in tandem with an electric drive system including a hub motor of the rear wheel.

As depicted in the schematic block diagram of FIG. 1, motor controller 100 is in electrical communication with a hub motor 102 of a vehicle 98 (AKA the electric bicycle). Hub motor 102 provides a rotational, driving force to the rear wheel of the electric bicycle. The drivetrain also includes a crankset 96 configured to receive human-powered input from a rider. The hub motor is under the automatic control of motor controller 100, which receives data from a plurality of inputs 104.

A battery 106 provides electrical power to motor controller 100, hub motor 102, and other electrical components present on the electric bicycle. Battery 106 may include a plurality of battery cells. In some examples, battery 106 comprises a lithium battery. In some examples, battery 106 comprises one or more lithium-ion phosphate battery cells, one or more lithium polymer battery cells, one or more lithium cobalt battery cells, one or more lithium manganese battery cells, and/or any combination thereof. In some examples, battery 106 is removably coupled to the frame or other structural component(s) of the bicycle. In some examples, battery 106 is non-removably coupled to the frame or other structural component(s) of the bicycle.

As shown in FIG. 1, inputs 104 may include user inputs 108, vehicle sensors 110, environmental sensors 112, and/or software inputs 114, each of which is described further below. Motor controller 100 is configured to receive data from inputs 104 and, in response, to control hub motor 102 to propel the electric vehicle based on some or all of the inputs. The rotation of hub motor 102 as controlled by motor controller 100 is environmentally dependent and proportional to the effort exerted by the rider, thereby providing a fluid motor response configured to augment the natural pedaling of the rider. In some examples, the motor controller utilizes a proportional-integral-derivative (PID) loop to determine an appropriate driving signal for the hub motor. One or more of the sensors may be integrated into the frame and/or handlebars of the electric bicycle.

The hub motor is coupled to the rear triangle assembly of the bicycle, for example using one or more fasteners (e.g., bolts, brackets, etc.). In some examples, hub motor 102 includes a stator rigidly affixed to the rear triangle assembly and a rotor disposed circumferentially around the stator. The rotor is operatively coupled to the rear wheel such that the rotor and wheel spin together, for example by way of a circumferential flange to which spokes of the wheel are connected. The hub motor may be internally geared, direct-drive, or any other suitable configuration.

In some embodiments, controller 100 provides real-time data (e.g., current speed, direction, temperature, etc.) to the rider, for example through a display 116 (e.g., integrated into or coupled to the handlebars). In some examples, the motor controller logs data (e.g., usage data, motion data, and/or other analytics) to a console 118 comprising a memory. In some examples, data communicated to console 118 is viewable on display 116. Additionally, data communicated with display 116 and console 118 may be accessible through a user interface of an external computing unit, such as a mobile application on a mobile device. Communication with the user interface may be wired and/or wireless, for example, through a USB cable, wireless network, Bluetooth®, etc. The user may interact with the user interface to retrieve data, customize controller operation, engage or disengage electric components, etc.

In some embodiments, controller 100 selectively sends power from battery 106 to a light 120. In some examples, light 120 comprises a plurality of LEDs. Light 120 may be integrated into the handlebars, frame, or other suitable structure of the electric bicycle. In some examples, light 120 includes a front light (e.g., headlight) and a back light (e.g., taillight). In some examples, light(s) 120 are configured to automatically brighten or dim depending on an ambient light of the bicycle, e.g., as measured by a light sensor.

In some embodiments, the electric bicycle may have auxiliary components such as an integrated lock, speakers, and/or a microphone adapted to provide interactive or autonomous features, such that the rider may concentrate solely on cycling.

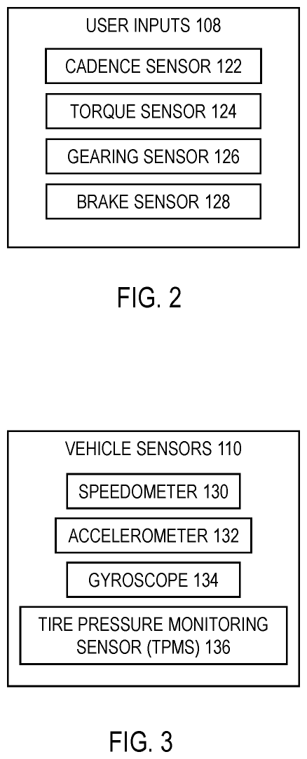

Turning to FIG. 2, user inputs 108 may include a cadence sensor 122, a torque sensor 124, gearing sensor 126, and/or a brake sensor 128. Cadence sensor 122 is configured to measure a pedal cadence (AKA pedaling rate) of the user. Cadence sensor 122 may be disposed on the frame, in or near a bottom bracket of the bicycle, on a crankarm, and/or near a pedal. Cadence sensor 122 provides motor controller 100 with the pedal cadence, and motor controller 100 is configured to adjust a rotational speed of hub motor 102 in response. The motor controller controls the rotational speed of the hub motor based on the measured cadence, e.g., in a linear or non-linear relationship.

Torque sensor 124 is configured to measure a torque on the crankset, for example, when force is applied to the pedals by the user. Motor controller 100 may utilize data from the torque sensor in concert with the cadence sensor to estimate a physical exertion of the user and automatically adjust the speed of hub motor 102 in response. For example, as user begins to pedal harder and/or faster, the motor controller may increase the speed of the hub motor to provide additional power to the rear wheel. (Although a rear wheel is referenced in these examples, either or both wheels of the e-bike may be powered, depending on the transmission arrangement of the specific vehicle).

Gearing sensor 126 is configured to provide data on a current gear ratio of the electric bicycle. In some examples, the bicycle includes a gearbox at or near the crankset. When a user changes the current gearing of the bicycle, e.g., using a shifting system, the gearing sensor communicates the new gear ratio to the motor controller. This may be especially useful when determining the speed at which the user intends to travel, e.g., when combined with cadence sensor 122. For example, if the electric bicycle is in a lower gear (such as when climbing a hill), the rider may have a faster pedal cadence for the intended speed than when the bicycle is in higher gear. Accordingly, the motor controller may set the hub motor speed slower than if the rider had a similar cadence at a higher gear. In another example, if the electric bicycle is in a high gear (such as when descending a hill), the rider may have a slower cadence relative to the speed (or intended speed) than when the bicycle is in a low gear. Accordingly, the motor controller may set the hub motor speed faster in these situations than if the rider had a similar cadence at a lower gear.

Brake sensor 128 is configured to determine whether a user is engaging a brake of the vehicle, and, in some examples, the amount at which the brake is engaged. Motor controller 100 is configured to lower the speed of hub motor 102 at a predetermined rate in response to brake sensor 128 detecting the brake is engaged. In some examples, if brake sensor 128 detects the user increasing pressure on a brake lever, motor controller 100 lowers the speed of hub motor 102 at a faster rate (e.g., increasing the braking power of the hub motor).

Turning to FIG. 3, vehicle sensors 110 may include a speedometer 130, an accelerometer 132, a gyroscope 134, and/or a tire pressure monitoring sensor (TPMS) 136.

Speedometer 130 is configured to measure a speed of the electric bicycle. In some examples, the speedometer comprises a tachometer configured to measure a rotations per minute (RPM) of one or more of the electric bicycle's wheels. In some examples, the speedometer includes a Hall-effect sensor. In some examples, the speedometer includes a GPS/satellite system (e.g., a GPS receiver on the bike). The data from the speedometer may be utilized by motor controller 100 in determining a speed for hub motor 102. For example, motor controller 100 may be configured to combine the data output from cadence sensor 122 and speedometer 130 to determine a speed for hub motor 102.

Accelerometer 132 is configured to measure an acceleration of the electric bicycle, on one or more axes. Accelerometer 132 may measure the acceleration in a direction parallel to the direction of travel and/or accelerometer 132 may measure the acceleration in a direction orthogonal to the direction of travel. Motor controller 100 may utilize data from the accelerometer to determine an acceleration to impart using hub motor 102. In some examples, motor controller 100 is configured to order a complementary acceleration. For example, when the rider is braking, the accelerometer may measure a negative acceleration in the direction of travel and, accordingly, impart a negative acceleration on hub motor 102 (i.e., decreasing the speed) to aid in braking, for example by imparting a counter-electromotive force (emf).

Motor controller 100 utilizes speedometer 130 and accelerometer 132 in concert with cadence sensor 122 to provide a natural-feeling motor response depending on the environment and riding characteristics of the rider. For example, if speedometer 130 measures a speed of 20 KPH, the cadence sensor measures a pedal cadence of 60 RPM, and the accelerometer detects the rider is currently climbing a hill, motor controller 100 may respond by increasing the power of hub motor 102 to aid in climbing the hill. This increase may continue until selected threshold(s) are satisfied, indicating that the rider's cadence and speed are such that no further assistance needed.

Gyroscope 134 is configured to measure an orientation of the electric bicycle (e.g., a pitch orientation and/or a roll orientation). In some examples, gyroscope 134 comprises a microelectromechanical systems (MEMS) gyroscope. In some examples, accelerometer 132 and gyroscope 134 may be included in an inertial measurement unit (IMU). Data from gyroscope 134 and accelerometer 132 may be utilized in concert to identify riding characteristics of the rider (e.g., speed of turns, rate of travel, etc.), and adjust operating characteristics of hub motor 102 accordingly. Pitch orientation may be utilized to determine whether the bike is travelling uphill or downhill.

TPMS 136 is configured to send tire pressure data to motor controller 100. In some examples, motor controller is configured to adapt the speed of hub motor 102 based on a measured tire pressure. For example, if TPMS 136 signals that the tire pressure has suddenly dropped (e.g., in the case of a low or flat tire), motor controller 100 may slow down or stop hub motor 102 to safely bring the electric bicycle to a stop.

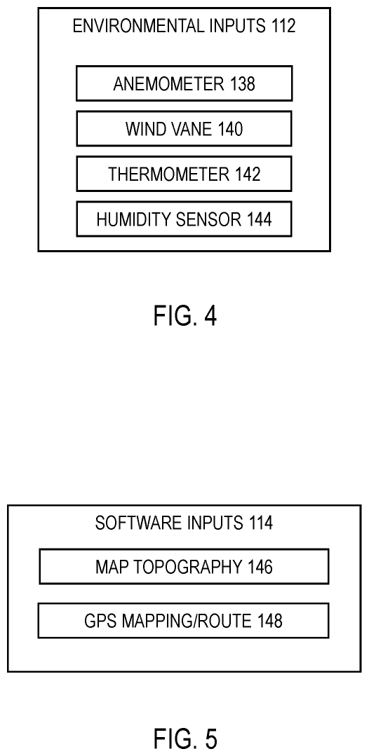

Turning to FIG. 4, environmental inputs 112 may include an anemometer 138, a wind vane 140, a thermometer 142, and/or a humidity sensor 144.

Motor controller 100 may utilize data from anemometer 138 and wind vane 140 to adapt the speed of hub motor 100. For example, if the electric bicycle is being ridden directly into high-speed wind, motor controller 100 may increase the speed of hub motor 102 to account for the force imparted by the wind on the bicycle and the rider. In another example, if the bicycle is being ridden with a strong tailwind, the motor controller may decrease the speed of hub motor 102 to ensure the bicycle maintains a safe operating speed.

Motor controller 100 may utilize data from thermometer 142 and humidity sensor 144 to ensure safe operation of hub motor 102. For example, if thermometer 142 measures a very high temperature, motor controller 100 may turn off hub motor 102 to avoid failure. Thermometer 142 may be configured to measure a temperature of the ambient environment around the electric bicycle and/or measure a temperature of the immediate environment around hub motor 102.

In some examples, data from environmental inputs 112 is sent to display 116 to inform the rider of the current operating conditions. In some examples, data from the environmental inputs 112 is sent to the user interface embedded in the external computing unit.

Turning to FIG. 5, software inputs 114 may include map topography data 146 and GPS mapping/route data 148. In some examples, software inputs 114 are provided by the external computing unit. Motor controller 100 may utilize map topography data 146 (e.g., based on a geographical location of the vehicle as determined by the GPS receiver) to preemptively adjust the speed of hub motor 102 to account for upcoming changes the incline in the direction of travel. For example, if the rider is approaching a large hill, motor controller 100 may increase the speed of hub motor 102 to provide more momentum to the rider during the approach to the climb. Motor controller 100 may utilize GPS mapping/route data 148 to preemptively adjust the speed of hub motor 102 to account for upcoming changes in direction. For example, if GPS mapping/route data indicates the user is expected to make a turn, motor controller 100 may decrease the speed of hub motor 102 to give the electric bicycle a safe turning speed.

### B. Illustrative Machine Learning System

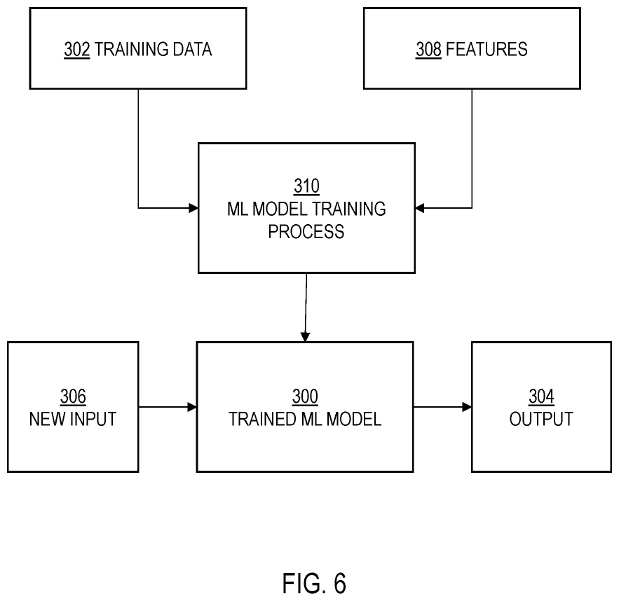

FIG. 6 depicts the training and use of an illustrative machine learning (ML) algorithm or model 300. As mentioned above, machine learning algorithms may be utilized in one or more aspects of motor controller 100, such as converting sensed data into a corresponding motor control signal (or component thereof). Accordingly, the processing logic of motor controller 100 may include or be in communication with one or more ML algorithms trained to provide desired motor control outputs based on the data from inputs 104.

In general, machine learning models (AKA ML algorithms, ML tools, or ML programs) may be utilized to generate predictions or decisions that are useful in themselves and/or in the service of a more comprehensive program. ML algorithms “learn” by example, based on existing sample data, and generate a trained model. Using the trained model, predictions or decisions can then be made regarding new data without explicit programming. Machine learning therefore involves algorithms or tools that learn from existing data and make predictions about novel data.

Training data 302 (e.g., labeled training data) is utilized to build trained ML model 300, such that the ML model can produce a desired output 304 when presented with new data 306. In general, the ML model uses labeled training data 302, which includes values for the input variables and values for the known correct outputs, to ascertain relationships and correlations between variables or features 308 to produce an algorithm mapping the input values to the outputs.

Supervised learning methods may be utilized for the purposes of producing classification or regression algorithms. Classification algorithms are typically used in situations where the goal is categorization (e.g., whether a photo contains a cat or a dog). Regression algorithms are typically used in situations where the goal is a numerical value (e.g., the market value of a house).

Features 308 may include any suitable characteristics capable of being measured and configured to provide some level of information regarding the input scenario, situation, or phenomenon. For example, if the goal is to provide an output relating to the market value of a house, then the features may include variables such as square footage, postal code, year built, lot size, number of bedrooms, etc. Although these example features are numeric, other feature types may be included, such as strings, Boolean values, etc.

Different ML techniques may be used, depending on the application. For example, artificial neural networks, decision trees, support-vector machines, regression analysis, Bayesian networks, genetic algorithms, random forests, and/or the like may be utilized to produce the trained ML model.

Trained ML model 300 is produced by training process 310 based on identified features 308 and training data 302. Trained ML model 300 can then be utilized to predict a category or decide an output value 304 based on new data 306.

With respect to the present disclosure, the electronic controller may include processing logic including one or more trained ML models configured to receive inputs (e.g., pedal cadence, vehicle orientation, etc.) and provide a motor control signal corresponding to the input values.

### C. Illustrative Data Processing System

As shown in FIG. 6, this example describes a data processing system 400 (also referred to as a computer, computing system, and/or computer system) in accordance with aspects of the present disclosure. In this example, data processing system 400 is an illustrative data processing system suitable for implementing aspects of the motor controller. More specifically, in some examples, devices that are embodiments of data processing systems (e.g., controller 100) may process input data from the plurality of sensors/inputs and produce an appropriate signal for controlling the hub motor.

In this illustrative example, data processing system 400 includes a system bus 402 (also referred to as communications framework). System bus 402 may provide communications between a processor unit 404 (also referred to as a processor or processors), a memory 406, a persistent storage 408, a communications unit 410, an input/output (I/O) unit 412, a codec 430, and/or a display 414. Memory 406, persistent storage 408, communications unit 410, input/output (I/O) unit 412, display 414, and codec 430 are examples of resources that may be accessible by processor unit 404 via system bus 402.

Processor unit 404 serves to run instructions that may be loaded into memory 406. Processor unit 404 may comprise a number of processors, a multi-processor core, and/or a particular type of processor or processors (e.g., a central processing unit (CPU), graphics processing unit (GPU), etc.), depending on the particular implementation. Further, processor unit 404 may be implemented using a number of heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices 416. A storage device may include any suitable hardware capable of storing information (e.g., digital information), such as data, program code in functional form, and/or other suitable information, either on a temporary basis or a permanent basis.

Storage devices 416 also may be referred to as computer-readable storage devices or computer-readable media. Memory 406 may include a volatile storage memory 440 and a non-volatile memory 442. In some examples, a basic input/output system (BIOS), containing the basic routines to transfer information between elements within the data processing system 400, such as during start-up, may be stored in non-volatile memory 442. Persistent storage 408 may take various forms, depending on the particular implementation.

Persistent storage 408 may contain one or more components or devices. For example, persistent storage 408 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 408 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 408 to system bus 402, a removable or non-removable interface is typically used, such as interface 428.

Input/output (I/O) unit 412 allows for input and output of data with other devices that may be connected to data processing system 400 (i.e., input devices and output devices). For example, an input device may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 404 through system bus 402 via interface port(s). Suitable interface port(s) may include, for example, a serial port, a parallel port, a game port, and/or a universal serial bus (USB).

One or more output devices may use some of the same types of ports, and in some cases the same actual ports, as the input device(s). For example, a USB port may be used to provide input to data processing system 400 and to output information from data processing system 400 to an output device. One or more output adapters may be provided for certain output devices (e.g., monitors, speakers, and printers, among others) which require special adapters. Suitable output adapters may include, e.g. video and sound cards that provide a means of connection between the output device and system bus 402. Other devices and/or systems of devices may provide both input and output capabilities, such as remote computer(s) 460. Display 414 may include any suitable human-machine interface or other mechanism configured to display information to a user, e.g., a CRT, LED, or LCD monitor or screen, etc.

Communications unit 410 refers to any suitable hardware and/or software employed to provide for communications with other data processing systems or devices. While communication unit 410 is shown inside data processing system 400, it may in some examples be at least partially external to data processing system 400. Communications unit 410 may include internal and external technologies, e.g., modems (including regular telephone grade modems, cable modems, and DSL modems), ISDN adapters, and/or wired and wireless Ethernet cards, hubs, routers, etc. Data processing system 400 may operate in a networked environment, using logical connections to one or more remote computers 460. A remote computer(s) 460 may include a personal computer (PC), a server, a router, a network PC, a workstation, a microprocessor-based appliance, a peer device, a smart phone, a tablet, another network note, and/or the like. Remote computer(s) 460 typically include many of the elements described relative to data processing system 400. Remote computer(s) 460 may be logically connected to data processing system 400 through a network interface 462 which is connected to data processing system 400 via communications unit 410. Network interface 462 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 430 may include an encoder, a decoder, or both, comprising hardware, software, or a combination of hardware and software. Codec 430 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 430 is depicted as a separate component, codec 430 may be contained or implemented in memory, e.g., non-volatile memory 442.

Non-volatile memory 442 may include read only memory (ROM), programmable ROM (PROM), electrically programmable ROM (EPROM), electrically erasable programmable ROM (EEPROM), flash memory, and/or the like, or any combination of these. Volatile memory 440 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 416, which are in communication with processor unit 404 through system bus 402. In these illustrative examples, the instructions are in a functional form in persistent storage 408. These instructions may be loaded into memory 406 for execution by processor unit 404. Processes of one or more embodiments of the present disclosure may be performed by processor unit 404 using computer-implemented instructions, which may be located in a memory, such as memory 406.

These instructions are referred to as program instructions, program code, computer usable program code, or computer-readable program code executed by a processor in processor unit 404. The program code in the different embodiments may be embodied on different physical or computer-readable storage media, such as memory 406 or persistent storage 408. Program code 418 may be located in a functional form on computer-readable media 420 that is selectively removable and may be loaded onto or transferred to data processing system 400 for execution by processor unit 404. Program code 418 and computer-readable media 420 form computer program product 422 in these examples. In one example, computer-readable media 420 may comprise computer-readable storage media 424 or computer-readable signal media 426.

Computer-readable storage media 424 may include, for example, an optical or magnetic disk that is inserted or placed into a drive or other device that is part of persistent storage 408 for transfer onto a storage device, such as a hard drive, that is part of persistent storage 408. Computer-readable storage media 424 also may take the form of a persistent storage, such as a hard drive, a thumb drive, or a flash memory, that is connected to data processing system 400. In some instances, computer-readable storage media 424 may not be removable from data processing system 400.

In these examples, computer-readable storage media 424 is a non-transitory, physical or tangible storage device used to store program code 418 rather than a medium that propagates or transmits program code 418. Computer-readable storage media 424 is also referred to as a computer-readable tangible storage device or a computer-readable physical storage device. In other words, computer-readable storage media 424 is media that can be touched by a person.

Alternatively, program code 418 may be transferred to data processing system 400, e.g., remotely over a network, using computer-readable signal media 426. Computer-readable signal media 426 may be, for example, a propagated data signal containing program code 418. For example, computer-readable signal media 426 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 418 may be downloaded over a network to persistent storage 408 from another device or data processing system through computer-readable signal media 426 for use within data processing system 400. For instance, program code stored in a computer-readable storage medium in a server data processing system may be downloaded over a network from the server to data processing system 400. The computer providing program code 418 may be a server computer, a client computer, or some other device capable of storing and transmitting program code 418.

In some examples, program code 418 may comprise an operating system (OS) 450. Operating system 450, which may be stored on persistent storage 408, controls and allocates resources of data processing system 400. One or more applications 452 take advantage of the operating system's management of resources via program modules 454, and program data 456 stored on storage devices 416. OS 450 may include any suitable software system configured to manage and expose hardware resources of computer 400 for sharing and use by applications 452. In some examples, OS 450 provides application programming interfaces (APIs) that facilitate connection of different type of hardware and/or provide applications 452 access to hardware and OS services. In some examples, certain applications 452 may provide further services for use by other applications 452, e.g., as is the case with so-called “middleware.” Aspects of present disclosure may be implemented with respect to various operating systems or combinations of operating systems.

The different components illustrated for data processing system 400 are not meant to provide architectural limitations to the manner in which different embodiments may be implemented. One or more embodiments of the present disclosure may be implemented in a data processing system that includes fewer components or includes components in addition to and/or in place of those illustrated for computer 400. Other components shown in FIG. 6 can be varied from the examples depicted. Different embodiments may be implemented using any hardware device or system capable of running program code. As one example, data processing system 400 may include organic components integrated with inorganic components and/or may be comprised entirely of organic components (excluding a human being). For example, a storage device may be comprised of an organic semiconductor.

In some examples, processor unit 404 may take the form of a hardware unit having hardware circuits that are specifically manufactured or configured for a particular use, or to produce a particular outcome or progress. This type of hardware may perform operations without needing program code 418 to be loaded into a memory from a storage device to be configured to perform the operations. For example, processor unit 404 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 418) may be implemented as hardware, e.g., by specifying an FPGA configuration using a hardware description language (HDL) and then using a resulting binary file to (re)configure the FPGA.

In another example, data processing system 400 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 404 may be implemented using a combination of processors found in computers and hardware units. Processor unit 404 may have a number of hardware units and a number of processors that are configured to run program code 418. With this depicted example, some of the processes may be implemented in the number of hardware units, while other processes may be implemented in the number of processors.

In another example, system bus 402 may comprise one or more buses, such as a system bus or an input/output bus. Of course, the bus system may be implemented using any suitable type of architecture that provides for a transfer of data between different components or devices attached to the bus system. System bus 402 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 410 may include a number of devices that transmit data, receive data, or both transmit and receive data. Communications unit 410 may be, for example, a modem or a network adapter, two network adapters, or some combination thereof. Further, a memory may be, for example, memory 406, or a cache, such as that found in an interface and memory controller hub that may be present in system bus 402.

### D. Illustrative Distributed Data Processing System

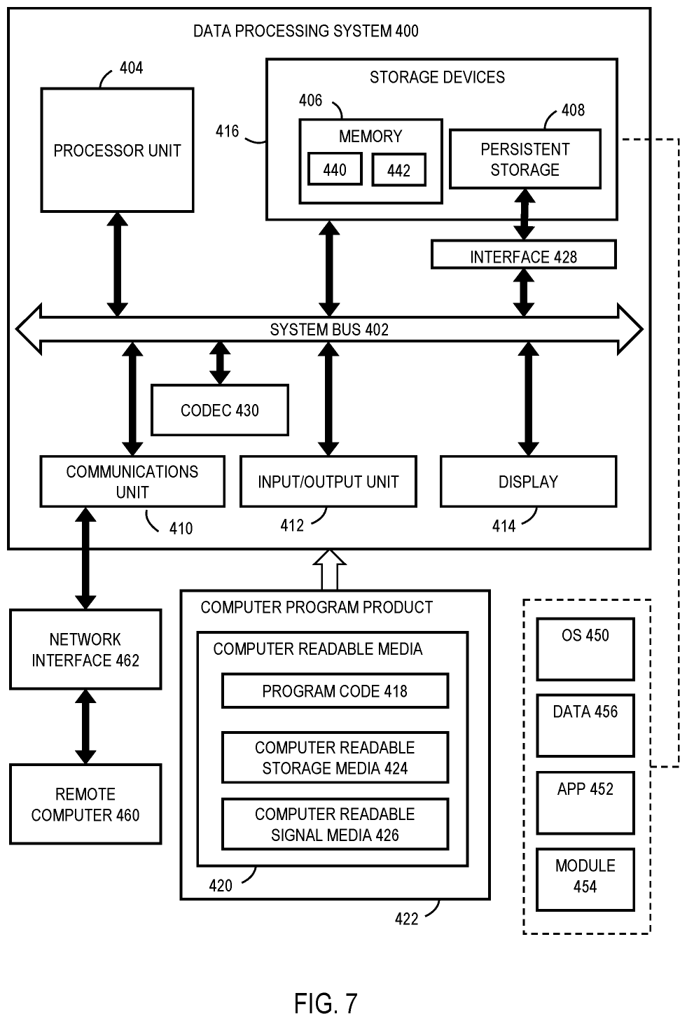

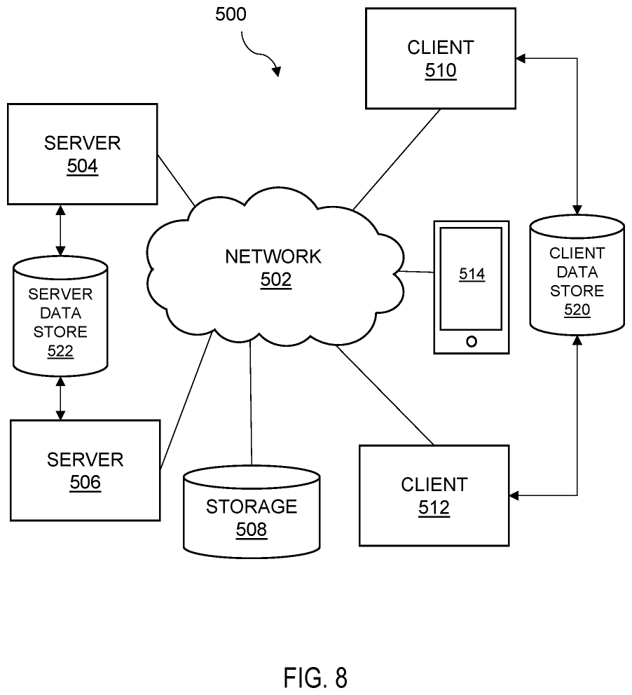

As shown in FIG. 7, this example describes a general network data processing system 500, interchangeably termed a computer network, a network system, a distributed data processing system, or a distributed network, aspects of which may be included in one or more illustrative embodiments of the motor controller. For example, communication of controller 100 with an external user interface may occur over a computer network.

It should be appreciated that FIG. 7 is provided as an illustration of one implementation and is not intended to imply any limitation with regard to environments in which different embodiments may be implemented. Many modifications to the depicted environment may be made.

Network system 500 is a network of devices (e.g., computers), each of which may be an example of data processing system 400, and other components. Network data processing system 500 may include network 502, which is a medium configured to provide communications links between various devices and computers connected within network data processing system 500. Network 502 may include connections such as wired or wireless communication links, fiber optic cables, and/or any other suitable medium for transmitting and/or communicating data between network devices, or any combination thereof.

In the depicted example, a first network device 504 and a second network device 506 connect to network 502, as do one or more computer-readable memories or storage devices 508. Network devices 504 and 506 are each examples of data processing system 400, described above. In the depicted example, devices 504 and 506 are shown as server computers, which are in communication with one or more server data store(s) 522 that may be employed to store information local to server computers 504 and 506, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 510 and 512 and/or a client smart device 514, may connect to network 502. Each of these devices is an example of data processing system 400, described above regarding FIG. 6. Client electronic devices 510, 512, and 514 may include, for example, one or more personal computers, network computers, and/or mobile computing devices such as personal digital assistants (PDAs), smart phones, handheld gaming devices, wearable devices, and/or tablet computers, and the like. In the depicted example, server 504 provides information, such as boot files, operating system images, and applications to one or more of client electronic devices 510, 512, and 514. Client electronic devices 510, 512, and 514 may be referred to as “clients” in the context of their relationship to a server such as server computer 504. Client devices may be in communication with one or more client data store(s) 520, which may be employed to store information local to the clients (e,g., cookie(s) and/or associated contextual information). Network data processing system 500 may include more or fewer servers and/or clients (or no servers or clients), as well as other devices not shown.

In some examples, first client electric device 510 may transfer an encoded file to server 504. Server 504 can store the file, decode the file, and/or transmit the file to second client electric device 512. In some examples, first client electric device 510 may transfer an uncompressed file to server 504 and server 504 may compress the file. In some examples, server 504 may encode text, audio, and/or video information, and transmit the information via network 502 to one or more clients.

Client smart device 514 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 500 may be stored in or on a computer-readable storage medium, such as network-connected storage device 508 and/or a persistent storage 408 of one of the network computers, as described above, and may be downloaded to a data processing system or other device for use. For example, program code may be stored on a computer-readable storage medium on server computer 504 and downloaded to client 510 over network 502, for use on client 510. In some examples, client data store 520 and server data store 522 reside on one or more storage devices 508 and/or 408.

Network data processing system 500 may be implemented as one or more of different types of networks. For example, system 500 may include an intranet, a local area network (LAN), a wide area network (WAN), or a personal area network (PAN). In some examples, network data processing system 500 includes the Internet, with network 502 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 502 may be referred to as a “cloud.” In those examples, each server 504 may be referred to as a cloud computing node, and client electronic devices may be referred to as cloud consumers, or the like. FIG. 7 is intended as an example, and not as an architectural limitation for any illustrative embodiments.

### F. Illustrative Combinations and Additional Examples

This section describes additional aspects and features of e-bikes having control systems configured to provide dynamic motor control, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. An electric pedal-assist bicycle, comprising:

a wheel rotatably coupled to a frame;

a drivetrain configured to drive the wheel, the drivetrain including a crankset and an electric motor;

a pedaling sensor configured to determine pedaling cadence information;

an orientation sensor configured to determine a pitch orientation of the bicycle; and

an electronic controller configured to drive the motor to propel the bicycle based on the pedaling cadence information and the pitch orientation.

A1. The electric pedal-assist bicycle of A0, wherein the electric motor comprises a hub motor coupled to the wheel.

A2. The electric pedal-assist bicycle of any one of paragraphs A0 through A1, wherein the controller is further configured to dynamically increase motor output in response to pitch orientation information indicating that the bicycle is traveling uphill.

A3. The electric pedal-assist bicycle of any one of paragraphs A0 through A2, wherein the controller is further configured to dynamically decrease motor output in response to pitch orientation information indicating that the bicycle is traveling downhill.

A4. The electric pedal-assist bicycle of any one of paragraphs A0 through A3, further comprising a Global Positioning System (GPS) receiver, wherein the electronic controller is further configured to drive the motor based on topographic information corresponding to a geographic location of the bicycle.

A5. The electric pedal-assist bicycle of any one of paragraphs A0 through A4, wherein the drivetrain comprises a drive chain coupling the crankset to the wheel.

A6. The electric pedal-assist bicycle of any one of paragraphs A0 through A5, wherein the electronic controller comprises processing logic including a machine learning (ML) model trained to provide a motor control signal based on the cadence information and the pitch orientation.

A7. The electric pedal-assist bicycle of A6, further comprising an environmental sensor configured to provide environmental information, wherein the ML model is configured to provide the motor control signal based on the cadence information, the pitch orientation, and the environmental information.

A8. The electric pedal-assist bicycle of A7, wherein the environmental sensor is an anemometer and the environmental information comprises a local wind speed and direction.

A9. The electric pedal-assist bicycle of A6, further comprising a Global Positioning System (GPS) receiver, wherein the electronic controller is further configured to drive the motor based on topographic information corresponding to a geographic location of the bicycle.

B0. An electric pedal-assist bicycle, comprising:

a wheel rotatably coupled to a frame;

a drivetrain configured to drive the wheel, the drivetrain including a crankset, a drive chain, and an electric hub motor;

an orientation sensor configured to determine pitch orientation information of the bicycle; and

an electronic controller configured to drive the motor to propel the bicycle based on the pitch orientation information.

B1. The electric pedal-assist bicycle of B0, wherein the controller is further configured to dynamically increase motor output in response to pitch orientation information indicating that the bicycle is traveling uphill.

B2. The electric pedal-assist bicycle of any one of paragraphs B0 through B1, wherein the controller is further configured to dynamically decrease motor output in response to pitch orientation information indicating that the bicycle is traveling downhill.

B3. The electric pedal-assist bicycle of any one of paragraphs B0 through B2, further comprising a pedaling sensor configured to determine pedaling cadence information; wherein the electronic controller is configured drive the motor based on the pitch orientation information and the pedaling cadence information.

B4. The electric pedal-assist bicycle of B3, wherein the electronic controller comprises processing logic including a machine learning (ML) model trained to provide a motor control signal based on the cadence information and the pitch orientation information.

B5. The electric pedal-assist bicycle of B4, further comprising an environmental sensor configured to provide environmental information, wherein the ML model is configured to provide the motor control signal based on the cadence information, the pitch orientation information, and the environmental information.

B6. The electric pedal-assist bicycle of B5, wherein the environmental sensor is an anemometer and the environmental information comprises a local wind speed and direction.

B7. The electric pedal-assist bicycle of any one of paragraphs B3 through B6, further comprising a Global Positioning System (GPS) receiver, wherein the electronic controller is further configured to drive the motor based on topographic information corresponding to a geographic location of the bicycle.

C0. A method for controlling an electric motor of an electric pedal-assist bicycle, the method comprising:

dynamically increasing an output of a motor of an electric pedal-assist bicycle using an electronic controller of the bicycle, based on an indication that the bicycle is traveling uphill; and

dynamically decreasing an output of the motor of the electric pedal-assist bicycle using the electronic controller of the bicycle, based on an indication that the bicycle is traveling downhill;

wherein the indication that the bicycle is traveling uphill and the indication that the bicycle is traveling downhill are each based on bicycle orientation information.

C1. The method of C0, wherein the indication that the bicycle is traveling uphill and the indication that the bicycle is traveling downhill are each further based on a pedaling cadence.

C2. The method of C0 or C1, wherein the indication that the bicycle is traveling uphill and the indication that the bicycle is traveling downhill are each further based on local topography information at a geographic location of the bicycle.

D0. An electric pedal-assist bicycle, comprising:

a wheel rotatably coupled to a frame;

a drivetrain configured to drive the wheel, the drivetrain including a crankset and an electric motor;

one or more inputs comprising information received from one or more of the following: user-related input(s), vehicle-related sensor(s), environmental sensor(s), and/or software; and

an electronic controller configured to drive the motor to propel the bicycle based on the one or more inputs.

D1. The bicycle of D0, wherein the electronic controller comprises one or more machine learning (ML) models trained to provide a motor control signal based on the one or more inputs.

D2. The bicycle of D0 or D1, wherein the user-related inputs comprise one or more of a pedaling cadence sensor, a torque sensor, a gearing sensor, and a braking sensor.

D3. The bicycle of any one of D0 through D2, wherein the vehicle-related sensors comprise one or more of a speedometer, an accelerometer, a gyroscope, and a tire pressure sensor.

D4. The bicycle of any one of D0 through D3, wherein the environmental sensors comprise one or more of an anemometer, a wind vane, a thermometer, and a humidity sensor.

D5. The bicycle of any one of D0 through D4, wherein the software inputs comprise one or more of a map topography and a global positioning system location and/or route.

### Advantages, Features, and Benefits

The different embodiments and examples of the motor controller described herein provide several advantages over known solutions for controlling a hub motor of an electric bicycle. For example, illustrative embodiments and examples described herein allow for inexpensive manufacturing of necessary components for controlling a hub motor of an electric bicycle.

Additionally, and among other benefits, illustrative embodiments and examples described herein allow relatively inexpensive replacement of parts to repair the electric bicycle.

Additionally, and among other benefits, illustrative embodiments and examples described herein allow for the manufacture of an inexpensive motor controller without compromising on performance.

Additionally, and among other benefits, illustrative embodiments and examples described herein allow a more natural feel in the motor response for the rider.

Additionally, and among other benefits, illustrative embodiments and examples described herein allow a safer riding experience due to the motor providing an augmentation to the rider's natural pedaling instead of a sudden acceleration.

Additionally, and among other benefits, illustrative embodiments and examples described herein allow an integrated smart system configured to provide autonomous features, such that the rider may concentrate solely on cycling.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An electric pedal-assist bicycle, comprising:
a wheel rotatably coupled to a frame;
a drivetrain configured to drive the wheel, the drivetrain including a crankset and an electric motor;
a pedaling sensor configured to determine pedaling cadence information;
an orientation sensor configured to determine a pitch orientation of the bicycle; and
an electronic controller configured to drive the motor to propel the bicycle based on the pedaling cadence information and the pitch orientation.

2. The electric pedal-assist bicycle of claim 1, wherein the electric motor comprises a hub motor coupled to the wheel.

3. The electric pedal-assist bicycle of claim 1, wherein the controller is further configured to dynamically increase motor output in response to pitch orientation information indicating that the bicycle is traveling uphill.

4. The electric pedal-assist bicycle of claim 1, wherein the controller is further configured to dynamically decrease motor output in response to pitch orientation information indicating that the bicycle is traveling downhill.

5. The electric pedal-assist bicycle of claim 1, further comprising a Global Positioning System (GPS) receiver, wherein the electronic controller is further configured to drive the motor based on topographic information corresponding to a geographic location of the bicycle.

6. The electric pedal-assist bicycle of claim 1, wherein the drivetrain comprises a drive chain coupling the crankset to the wheel.

7. The electric pedal-assist bicycle of claim 1, wherein the electronic controller comprises processing logic including a machine learning (ML) model trained to provide a motor control signal based on the cadence information and the pitch orientation.

8. The electric pedal-assist bicycle of claim 7, further comprising an environmental sensor configured to provide environmental information, wherein the ML model is configured to provide the motor control signal based on the cadence information, the pitch orientation, and the environmental information.

9. The electric pedal-assist bicycle of claim 8, wherein the environmental sensor is an anemometer and the environmental information comprises a local wind speed and direction.

10. The electric pedal-assist bicycle of claim 7, further comprising a Global Positioning System (GPS) receiver, wherein the electronic controller is further configured to drive the motor based on topographic information corresponding to a geographic location of the bicycle.

11. An electric pedal-assist bicycle, comprising:
a wheel rotatably coupled to a frame;
a drivetrain configured to drive the wheel, the drivetrain including a crankset, a drive chain, and an electric hub motor;
an orientation sensor configured to determine pitch orientation information of the bicycle; and
an electronic controller configured to drive the motor to propel the bicycle based on the pitch orientation information.

12. The electric pedal-assist bicycle of claim 11, wherein the controller is further configured to dynamically increase motor output in response to pitch orientation information indicating that the bicycle is traveling uphill.

13. The electric pedal-assist bicycle of claim 11, wherein the controller is further configured to dynamically decrease motor output in response to pitch orientation information indicating that the bicycle is traveling downhill.

14. The electric pedal-assist bicycle of claim 11, further comprising a pedaling sensor configured to determine pedaling cadence information; wherein the electronic controller is configured drive the motor based on the pitch orientation information and the pedaling cadence information.

15. The electric pedal-assist bicycle of claim 14, wherein the electronic controller comprises processing logic including a machine learning (ML) model trained to provide a motor control signal based on the cadence information and the pitch orientation information.

16. The electric pedal-assist bicycle of claim 15, further comprising an environmental sensor configured to provide environmental information, wherein the ML model is configured to provide the motor control signal based on the cadence information, the pitch orientation information, and the environmental information.

17. The electric pedal-assist bicycle of claim 16, wherein the environmental sensor is an anemometer and the environmental information comprises a local wind speed and direction.

18. The electric pedal-assist bicycle of claim 15, further comprising a Global Positioning System (GPS) receiver, wherein the electronic controller is further configured to drive the motor based on topographic information corresponding to a geographic location of the bicycle.

19. A method for controlling an electric motor of an electric pedal-assist bicycle, the method comprising:
dynamically increasing an output of a motor of an electric pedal-assist bicycle using an electronic controller of the bicycle, based on an indication that the bicycle is traveling uphill; and
dynamically decreasing an output of the motor of the electric pedal-assist bicycle using the electronic controller of the bicycle, based on an indication that the bicycle is traveling downhill;
wherein the indication that the bicycle is traveling uphill and the indication that the bicycle is traveling downhill are each based on bicycle orientation information and a pedaling cadence.

20. The method of claim 19, wherein the indication that the bicycle is traveling uphill and the indication that the bicycle is traveling downhill are each further based on local topography information at a geographic location of the bicycle.
